(19) United States
(12) Patent Application Publication
(10) Pub. No.: US 2010/0264089 A1
(43) Pub. Date: Oct. 21, 2010

(54) Method and apparatus for providing magnetic fluid treatment with programmable electrical energy

(76) Inventor: Herbert William Holland, Houston, TX (US)

Correspondence Address: Mr. Herbert W. Holland, 2314 Chimney Rock Road, Houston, TX, 77056, US

(21) Appl. No.: 12/386,233

(22) Filed: Apr. 15, 2009

(51) Int. Cl. B01J 19/08; B01D 35/06; C02F 1/48; B01D 17/12

(52) U.S. Cl. 210/695; 210/222; 210/223; 204/557; 204/663; 210/198.1

(57) ABSTRACT

A method and apparatus provide fluid treatment utilizing an electrical power supply providing at least one distinct programmable output of electrical energy wherein one or more of the voltage, current, repetition rate, amplitude or wavelength of the programmable output establish at least one distinct electrical signal generating concentrated magnetic in a plurality of distinct areas.

### BACKGROUND OF THE INVENTION

U.S. Pat. Nos. 6,706,196 B2, 6,730,205 B2, 6,852,235 B2 and 7,407,589 B2 disclose a method and apparatus of fluid treatment utilizing a configuration of a magnetically conductive conduit, a fluid flow conduit, a coiled electrical conductor and a supply of electrical energy having a capacity to energize the coiled electrical conductor and produce an electromagnetic field having concentrated magnetic energy concentrated in a plurality of distinct areas along the flow path of a fluid. However, it has been discovered that the utilization of an electrical power supplies providing a plurality of different programmable outputs of electrical energy to energize the coiled electrical conductor can produce a variety of energy efficient means of enhancing the performance of many existing fluid treatment systems.

Improved treatment translates into lower costs to generate quality processed fluids while maintaining environmental stewardship. The benefits of utilizing the instant invention are reduced chemical consumption, improved fluid clarification, increased throughput of fluid processing equipment, environmentally friendly means of meeting compliance standards and enhanced separation of components in feedstocks not utilizing chemical treatment.

Chemical additives are utilized in a wide variety of fluid treatment processes, and the cost and complexity of acquiring, transporting, storing and dispensing these chemicals adds to the burden of providing effective fluid treatment. Concentrated electromagnetic energy generated by the instant invention provides chemical additives commonly required for processing many fluids (e.g. coagulating polymers for clarifying wastewater and algaecides, biocides and scale retardants used in thermal exchange systems) with a means of rapidly and evenly dispersing throughout a fluid column. End-users realize a cost-effective means of enhancing the performance of their existing fluid treatment systems through reduced chemical costs and eliminating the need for additional downstream processing.

### SUMMARY OF THE INVENTION

The instant invention subjects feedstocks to a plurality of intense magnetic fields, any of which may be generated with an electrical power supply providing at least one distinct programmable output of electrical energy wherein one or more of the voltage, current, repetition rate, amplitude or wavelength of the programmable output establishes at least one distinct electrical signal.

The instant invention has proven to be useful in reducing the amount of fluid treatment chemicals required to adequately treat a candidate feed stream. The instant invention does not remove contaminants from a fluid column. Rather, it provides concentrated electromagnetic energy along the flow path of a fluid, and this typically elevates the surface polarity of the fluid while simultaneously reducing the surface tension of the fluid. For example, elevating the surface polarity of non-pure water (tap water or well water) causes naturally occurring minerals dissolved in the water, such as calcium carbonate and magnesium, to be rejected from the bulk of the water and toward its surface. The rejection of trace organics from the bulk of the water has a similar effect to the addition of a mild surfactant to promote wetting and lowers the overall surface tension of the water.

Elevating the surface polarity of water improves the activity of surfactants, allowing for the formation of surfactant aggregates at lower concentrations in a solution. Surface active agents are typically forced to the surface of a volume of water because they lack sufficient polar interactions for the bulk of the water to embrace the surfactant. However, the instant invention differs from simply using a surfactant to modify surface tension because it reduces the surface tension of the water throughout the entire bulk of a treated water column instead of just at the surface of the water. Therefore, less soap (i.e. fluid treatment chemical) is needed to produce a desired effect in a treated water column than the amount of soap (chemical) required to achieve a similar effect in a non-treated water column.

The instant invention provides more magnetic energy for fluid treatment than other electromagnetic fluid treatment systems. While other systems struggle to induce 200 gauss of electromagnetic energy to a fluid column in only one fluid treatment region, a feedstock directed to pass through the apparatus of the instant invention may be exposed to concentrated electromagnetic energy inducing more than 500 gauss, 1100 gauss and 2200 gauss in a plurality of distinct areas of along the flow path of the fluid. Further, this concentrated fluid treatment energy is typically generated while consuming less electrical energy than that required to drive other available electromagnetic fluid treatment system.

Prior art methods and apparatus of fluid treatment utilize a configuration of a magnetically conductive conduit, a fluid flow conduit, a coiled electrical conductor and merely disclose supply of electrical energy having a capacity to energize the coiled electrical conductor and produce an electromagnetic field concentrated in a plurality of distinct areas along the flow path of a fluid. It has been discovered the utilization of different programmable outputs of electrical energy to energize the coiled electrical conductor can produce a variety of fluid treatment options. For example, samples of a sludge comprising water and biological contaminants treated with a common magnetically conductive conduit/fluid flow conduit/coiled electrical conductor configuration but energized with a variety of programmable outputs of electrical energy produce different treatment results.

An untreated sample of the bio sludge decanted into a 100 ml tube and subjected to gravity separation for twenty four hours results in some solid components of the sludge rising to the top of the aqueous solution and some solid components falling to the bottom of the tube so that a volume of cloudy water that is relatively free of solid contaminants is found between the layers of solid contaminants. However, twenty four hours of gravity separation of a sample of the same bio sludge treated with a magnetically conductive conduit/fluid flow conduit/coiled electrical conductor configuration energized with distinct electrical signal providing a constant flow of electrical energy having a direct current component and inducing a negatively charged magnetic field to the sludge flowing through the magnetically conductive conduit results in the solid components of the sludge rising to the top of the tube and floating on a volume of clear water residing in the bottom of the tube.

Twenty four hours of gravity separation of a sample of the same bio sludge treated with the same magnetically conductive conduit/fluid flow conduit/coiled electrical conductor configuration energized with distinct electrical signal providing a pulsed flow of electrical energy having an alternating current component and inducing an alternating positively charged magnetic field and negatively charged magnetic field to the sludge sample flowing through the magnetically conductive conduit results in the solid components of the sludge dropping to the bottom of the sample tube and a volume of clear water residing above the solid contaminants that had settled to the base of the tube. Further, gravity separation of a sample of the same bio sludge treated with the same magnetically conductive conduit/fluid flow conduit/coiled electrical conductor configuration energized with distinct electrical signal providing a constant flow of electrical energy having a direct current component and inducing a positively charged magnetic field to the sludge sample flowing through the magnetically conductive conduit results in a portion of the solid components rising to the top of the tube, the remainder of the solid components falling to the bottom of the tube and a volume of clear water between the layers of solid contaminants.

Thus, utilizing an electrical power supply providing a variety of distinct programmable outputs of electrical energy to energize the coiled electrical conductor of the instant invention provides numerous fluid treatment options. The voltage, current, repetition rate, amplitude or wavelength of a distinct programmable outputs of electrical energy energizing the coiled electrical conductor may be established according to one or more of the composition of a fluid to be treated, material comprising the coiled electrical conductor, dimensions of the coiled electrical conductor, configuration of the coiled electrical conductor, resistance of the coiled electrical conductor, impedance of the coiled electrical conductor, material comprising the coil core, dimensions of the coil core, configuration of the coil core, resistance of the coil core, material comprising the magnetically conductive conduit, dimensions of the magnetically conductive conduit, configuration of the magnetically conductive conduit, material comprising the at least one non-magnetically conductive fluid flow conduit, dimensions of the at least one non-magnetically conductive fluid flow conduit and configuration of the at least one non-magnetically conductive fluid flow conduit.

The instant invention includes a method of providing fluid treatment, comprising the steps of providing a magnetically conductive conduit, said magnetically conductive conduit comprising at least one length of magnetically conductive material defining a fluid impervious boundary wall with an inner surface and an outer surface and having a port at the proximal end of the conduit and a port at the distal end of the conduit; providing at least one fluid flow conduit to promote a flow of a fluid through the magnetically conductive conduit, each at least one fluid flow conduit comprising a length of non-magnetically conductive material defining a fluid impervious boundary wall with an inner surface and an outer surface and having inlet and outlet ports and providing an electrical conductor, said electrical conductor comprising at least one length of an electrical conducting material having a first conductor lead and a second conductor lead.

The electrical conductor may be coiled to form at least one uninterrupted layer of coiled electrical conductor and a means for sleeving the magnetically conductive conduit within the coiled electrical conductor may be provided, whereby at least one coil of electrical conductor encircles at least a segment of the outer surface of each length of magnetically conductive material comprising said magnetically conductive conduit. A means for deploying the at least one fluid flow conduit proximate the magnetically conductive conduit is also provided.

The instant method of providing fluid treatment includes providing at least one electrical power supply, each at least one electrical power supply providing at least one distinct programmable output of electrical energy wherein one or more of the voltage, current, repetition rate, amplitude or wavelength of the programmable output establishes at least one distinct electrical signal and connecting the conductor leads of the coiled electrical conductor to the at least one electrical power supply to energize the coiled electrical conductor and produce a magnetic field having energy substantially confined within the boundary wall of the magnetically conductive conduit, said magnetic field extending beyond an end of each length of magnetically conductive material comprising said magnetically conductive conduit and having energy concentrated in a plurality of distinct areas along the longitudinal axis of the magnetically energized conduit.

The instant method of providing fluid treatment also includes introducing a feed stream comprising a fluid column receptive to magnetic treatment to the inlet port of at least one fluid flow conduit to establish a flow of a fluid to be treated through proximal end of the magnetically conductive conduit; directing the flow to pass through the plurality of distinct areas of concentrated magnetic energy along a path extending through and substantially orthogonal to each turn of the electrical conductor forming the coil surrounding the outer surface of the magnetically conductive conduit; and discharging the fluid exiting from the port at the distal end of the magnetically conductive conduit a processed feed stream.

The supply of electrical power is of sufficient magnitude to induce a magnetic field to fluid passing through the magnetically conductive conduit so that the coiled electrical conductor induces a magnetic field to which fluid passing through the magnetically conductive conduit is exposed.

The voltage and current of the at least one distinct electrical signal providing a constant flow of electrical energy having a direct current component are programmable. When energizing the coiled electrical conductor with a constant flow of electrical energy having a direct current component to produce the magnetic field, the polarity of the concentrated magnetic energy inducing treatment to a fluid passing through the magnetically conductive conduit may be established by connecting the first conductor lead of the coiled electrical conductor the positive terminal of the electrical power supply and the second conductor lead of the coiled electrical conductor the negative terminal of the electrical power supply. To reverse the polarity of the magnetic energy providing fluid treatment, the first conductor lead of the same coiled electrical conductor may be connected to the negative terminal of the electrical power supply and the second conductor lead of the coiled electrical conductor may be connected to the positive terminal of the electrical power supply.

The coiled electrical conductor may be energized by at least one electrical power supply providing at least one output of electrical energy establishing at least one distinct electrical signal providing a pulsed flow of electrical energy having a direct current component. This pulsed electrical signal may be established through a switching sequence comprising initially switching an output of electrical energy to an “on” state during a first time interval to energize the coiled electrical conductor with electrical energy flowing from the first conductor lead to the second conductor lead, switching said first output of electrical energy to an “off” state to interrupt the energizing of the coiled electrical conductor, switching an output of electrical energy to the “on” state during a second time interval to energize the coiled electrical conductor with electrical energy flowing from the first conductor lead to the second conductor lead, switching said second output of electrical energy to the “off” state to interrupt the energizing of the coiled electrical conductor and causing the switching sequence to repeat at some repetition rate.

The voltage, current, repetition rate, amplitude and wavelength of the at least one distinct electrical signal providing a pulsed flow of electrical energy having a direct current component are programmable. When energizing the coiled electrical conductor with a pulsed flow of electrical energy having a direct current component to produce the magnetic field, the polarity of the concentrated magnetic energy inducing treatment to a fluid passing through the magnetically conductive conduit may be established by connecting the first conductor lead of the coiled electrical conductor the positive terminal of the electrical power supply and the second conductor lead of the coiled electrical conductor the negative terminal of the electrical power supply. To reverse the polarity of the magnetic energy providing fluid treatment, the first conductor lead of the same coiled electrical conductor may be connected to the negative terminal of the electrical power supply and the second conductor lead of the coiled electrical conductor may be connected to the positive terminal of the electrical power supply.

The coiled electrical conductor may also be energized by at least one electrical power supply providing at least one output of electrical energy establishing at least one distinct electrical signal providing a pulsed flow of electrical energy having an alternating current component. This pulsed electrical signal may be established through a switching sequence comprising initially switching an output of electrical energy to an “on” state during a first time interval to energize the coiled electrical conductor with electrical energy flowing between the first conductor lead to the second conductor lead in a first direction, switching said first output of electrical energy to an “off” state to interrupt the energizing of the coiled electrical conductor, reversing the direction of the flow of electrical energy, switching an output of electrical energy to the “on” state during a second time interval to energize the coiled electrical conductor with electrical energy flowing between the first conductor lead to the second conductor lead in a second direction, switching said second output of electrical energy to the “off” state to interrupt the energizing of the coiled electrical conductor and causing the switching sequence to repeat at some repetition rate. The voltage, current, repetition rate, amplitude and wavelength of the at least one distinct electrical signal providing a pulsed flow of electrical energy having an alternating current component are programmable.

The instant method of fluid treatment may further comprise the step of dispersing a supply of at least one fluid treatment chemical into the feed stream. At least one chemical dispersing apparatus may be configured to distribute a supply of at least one fluid treatment chemical into a feed stream upstream of the magnetically energized conduit or downstream of the magnetically energized conduit.

The instant method of fluid treatment may further comprise the step of directing the feed steam to pass through at least one contaminant separation apparatus. At least one contaminant separation apparatus may be configured to facilitate the separation and collection of contaminants from a fluid upstream of the magnetically energized conduit or downstream of the magnetically energized conduit.

The instant method of fluid treatment may further comprise the step of directing the feed steam through at least one fluid flow conditioning apparatus. At least one fluid conditioning apparatus may be configured to condition the flow of a feed stream upstream of the magnetically energized conduit or downstream of the magnetically energized conduit.

### DESCRIPTION OF THE PREFERRED EMBODIMENT

The instant invention includes an apparatus providing fluid treatment, said apparatus comprising a magnetically conductive conduit, said magnetically conductive conduit comprising at least one length of magnetically conductive material defining a fluid impervious boundary wall with an inner surface and an outer surface and having a port at the proximal end of the conduit and a port at the distal end of the conduit; at least one fluid flow conduit to promote a flow of a fluid through the magnetically conductive conduit, each at least one fluid flow conduit comprising a length of non-magnetically conductive material defining a fluid impervious boundary wall with an inner surface and an outer surface and having inlet and outlet ports; an electrical conductor comprising at least one length of an electrical conducting material having a first conductor lead and a second conductor lead, said electrical conductor coiled to form at least one uninterrupted layer of coiled electrical conductor and means for sleeving the magnetically conductive conduit within the coiled electrical conductor, whereby at least one coil of electrical conductor encircles at least a segment of the outer surface of each length of magnetically conductive material comprising said magnetically conductive conduit.

The apparatus of the instant invention also includes means for deploying the at least one fluid flow conduit proximate the magnetically conductive conduit and at least one electrical power supply providing at least one distinct programmable output of electrical energy wherein one or more of the voltage, current, repetition rate, amplitude or wavelength of the programmable output establishes at least one distinct electrical signal having a capacity to energize the coiled electrical conductor and produce a magnetic field having energy substantially confined within the boundary wall of the magnetically conductive conduit, said magnetic field extending beyond an end of each length of magnetically conductive material comprising said magnetically conductive conduit and having energy concentrated in a plurality of distinct areas along the longitudinal axis of the magnetically energized conduit.

The magnetically conductive conduit may comprise a length of magnetically conductive material defining a fluid impervious boundary wall with an inner surface and an outer surface and having a port at the proximal end of the conduit and a port at the distal end of the conduit.

The magnetically conductive conduit may comprise a sheet of magnetically conductive material rolled to form a plurality of layers of magnetically conductive material whereby each outer layer of the rolled sheet is in substantially concentric surrounding relation the adjacent internal layer of the rolled sheet to form a tubular conduit defining a boundary wall with an inner surface and an outer surface and having a port at the proximal end of the tube and a port at the distal end of the tube.

The magnetically conductive conduit may comprise a non-contiguous array of a first magnetically conductive conduit and a second magnetically conductive conduit. Each magnetically conductive conduit may comprise a length of magnetically conductive material defining a fluid impervious boundary wall with an inner surface and an outer surface and having a port at the proximal end of the conduit and a port at the distal end of the conduit. A space between the first and second magnetically conductive conduits establishes a non-magnetically conductive region providing for a concentration of magnetic energy between the magnetically conductive conduits.

The first magnetically conductive conduit may be sleeved within a first coiled electrical conductor and the second magnetically conductive conduit may be sleeved within a second coiled electrical conductor or the first magnetically conductive conduit, the non-magnetically conductive region between the magnetically conductive conduits and the second magnetically conductive conduit may be sleeved within the coiled electrical conductor.

The magnetically conductive conduit may comprise a serial coupling of a magnetically conductive inlet conduit segment, a non-magnetically conductive intermediate conduit segment and a magnetically conductive outlet conduit segment. Each conduit segment may comprise a length of material defining a fluid impervious boundary wall with an inner surface and an outer surface and having a port at the proximal end of the conduit segment and a port at the distal end of the conduit segment. This serial coupling of conduit segments establishes a non-magnetically conductive region between the magnetically conductive inlet conduit segment and the magnetically conductive outlet conduit segment providing for a concentration of magnetic energy between the magnetically conductive conduit segments.

The magnetically conductive inlet conduit segment may be sleeved within a first coiled electrical conductor and the magnetically conductive outlet conduit segment may be sleeved within a second coiled electrical conductor or the serial coupling of conduit segments may be sleeved within the coiled electrical conductor.

The magnetically conductive conduit may comprise a first magnetically conductive conduit sleeved within a second magnetically conductive conduit so that the inner surface of the boundary wall of the second magnetically conductive conduit is coaxially disposed in substantially concentric surrounding relation to the outer surface of the boundary wall of the first magnetically conductive conduit. Each magnetically conductive conduit may comprise a length of magnetically conductive material defining a fluid impervious boundary wall with an inner surface and an outer surface and having a port at the proximal end of the conduit and a port at the distal end of the conduit.

The magnetically conductive conduit may comprise a non-contiguous array of a first magnetically conductive conduit and a second magnetically conductive conduit sleeved within a third magnetically conductive conduit, whereby the inner surface of the boundary wall of the third magnetically conductive conduit is coaxially disposed in substantially concentric surrounding relation to the outer surface of the boundary walls of the non-contiguous array of the first and second magnetically conductive conduits. Each magnetically conductive conduit may comprise a length of magnetically conductive material defining a fluid impervious boundary wall with an inner surface and an outer surface and having a port at the proximal end of the conduit and a port at the distal end of the conduit. A space between the first and second magnetically conductive conduits establishes a non-magnetically conductive region providing for a concentration of magnetic energy between the first and second magnetically conductive conduits.

The boundary wall of the third magnetically conductive conduit may be split along its longitudinal axis into preferably equal sections then rejoined proximate the outer surface of the fluid impervious boundary walls of the first and second magnetically conductive conduits so that the third magnetically conductive conduit sleeves the non-contiguous array of the first and second magnetically conductive conduits. A sheet of magnetically conductive material may be rolled in concentric surrounding relation the outer surface of the fluid impervious boundary walls of the first and second magnetically conductive conduits to establish a third magnetically conductive conduit sleeving the non-contiguous array of the first magnetically conductive conduit and the second magnetically conductive conduit.

A protective coating may be applied to the inner surface or the outer surface of the fluid impervious boundary wall of the magnetically conductive conduit. An end of the fluid impervious boundary wall of the magnetically conductive conduit may be tapered.

It may be advantageous to include a thin sheet of a non-magnetically conductive material or a coat of epoxy resin between the outer surface of the fluid impervious boundary wall of the magnetically conductive conduit and the coiled electrical conductor to maintain the alignment of the coiled electrical conductor and enhance the mechanical stability of the coiled electrical conductor. Further, a sheet of a non-magnetically conductive material or a coat of epoxy resin may envelope each layer of coiled electrical conductor to maintain the alignment of the coil and form a protective coating.

In the preferred embodiment of the instant invention, the coiled electrical conductor may comprise a continuous strand of an electrical conducting material having a first conductor lead and a second conductor lead wound into a coil so that each turn of the continuous strand of electrical conductor is contiguous with the adjacent turn of coiled electrical conductor. An uninterrupted layer of coiled electrical conductor is preferred. Winding of the electrical conducting material may result in small gaps or openings between adjacent turns of the continuous coil. Such gaps serve no beneficial purpose and may in fact result in hot spots within the continuous coil and impede its performance. Uninterrupted layers of a continuous strand of coiled electrical conductor, with each turn of the electrical conducting material being contiguous with its adjacent turn, provide the most efficient means of generating the electromagnetic field of the instant invention.

The electromagnetic field strength may be increased by concentrating the magnetic flux of each layer of coiled electrical conductor as near the center of the magnetically conductive conduit as possible. Once a desired length of a continuous coil layer is wound, a second layer of the coiled electrical conductor having a similar length to the initial layer may be placed atop the first layer of coiled electrical conductor.

The coiled electrical conductor may also comprise a continuous sheet of an electrical conducting foil material having a first conductor lead and a second conductor lead. The foil may be wound so that each outer layer of the sheet is in substantially concentric surrounding relation to its adjacent internal layer to form a plurality of layers of coiled electrical conductor.

The coiled electrical conductor may sleeve the magnetically conductive conduit to form at least one layer of electrical conductor encircling the magnetically conductive conduit with the coils oriented substantially orthogonal to the fluid flow. The energized coil forms an electromagnet establishing a magnetic field having lines of flux directed along the flow path of a fluid with magnetic energy concentrated in a plurality of distinct areas along the longitudinal axis of the magnetically energized conduit.

The lines of flux form loops and the magnetic field is of a strength that allows the flux to extend along the longitudinal axis of the magnetically energized conduit and concentrate at distinct points beyond each end of the magnetically energized conduit such that the magnetic flux extends from a point where the lines of flux concentrate beyond one end of the magnetically energized conduit, around the periphery of the coiled electrical conductor along the longitudinal axis of the magnetically energized conduit and to a point where the lines of flux concentrate beyond the other end of the magnetically energized conduit.

The instant apparatus may include a coil core comprising a tubular conduit defining a boundary wall with an inner surface and an outer surface and having a port at the proximal end of the tube and a port at the distal end of the tube. The outer surface of the boundary wall of the tube may be adapted to receive the coiled electrical conductor and the inner surface of the boundary wall of the tube may be adapted to sleeve the magnetically conductive conduit so that the inner surface of the boundary wall of the coil core may be coaxially disposed in substantially concentric surrounding relation to the outer surface of the boundary wall of the magnetically conductive conduit.

The coil core may be configured so that at least one coil of electrical conductor encircles at least a segment of the outer surface of each length of magnetically conductive material comprising the magnetically conductive conduit. The coil core may comprise a magnetically conductive material or the coil core may comprise a non-magnetically conductive material. A sheet of material may be rolled to form a plurality of layers of whereby each outer layer of the rolled sheet is in substantially concentric surrounding relation the adjacent internal layer of the rolled sheet to form a coil core tube defining a boundary wall with an inner surface and an outer surface and having a port at the proximal end of the tube and a port at the distal end of the tube.

Heat dissipation is critical to the overall efficiency and effectiveness of electromagnetic field generators. Heat generated by the internal layer of a coil contiguous with a magnetically conductive conduit may radiate through the conduit and into a fluid flowing through it. Heat generated by the outer layer of the coiled electrical conductor may dissipate into the atmosphere if the device is used in an open-air configuration or transferred to an enclosure and then into the atmosphere when the coil is encased within a protective housing. However, the inability of prior art devices to transfer and dissipate heat generated by their internal layers of coiled electrical conductor typically results in heat related open circuits or short circuits. Thus, prior art devices are typically limited in the number of layers of coiled electrical conductor that may be utilized to produce an electromagnetic field due to the generation and retention of heat within the layers of coiled electrical conductor.

The electrical conductor of the instant method may be coiled to form a pattern of open-air cooling ducts extending substantially parallel to the longitudinal axis of the magnetically conductive conduit, said open-air cooling ducts having a property of acting to dissipate heat from between the internal layers of coiled electrical conductor. Once a required number of turns of coiled electrical conductor have been wound to achieve the desired length of an internal layer of a continuous coil of electrical conducting material, a pattern of spacers may be placed on top of the layer of coiled electrical conductor. The spacers are typically of an identical length to that of the initial layer of coiled electrical conductor and may be arranged substantially parallel to the longitudinal axis of the coiled electrical conductor and equidistant to an adjacent spacer. A second layer of coiled electrical conductor may then be wrapped around the outer facing surface of the spacers so that the pattern of spacers separates the coaxially disposed, radially spaced layers of the coiled electrical conductor and forms a system of open-air cooling ducts between the layers of the coiled electrical conductor. Additional layers of coiled electrical conductor, spacers or both may be added to achieve the desired configuration of the coiled electrical conductor.

Thus, the electrical conductor forms a first layer of coiled electrical conductor and a second layer of coiled electrical conductor, said first and second layers of coiled electrical conductor being coaxially disposed and having a plurality of spacers deployed between said coil layers to establish radial spacing therebetween. The spacers are arranged substantially parallel to the longitudinal axis of the magnetically conductive conduit and equidistant to an adjacent spacer to form a pattern of open-air cooling ducts extending substantially parallel to the longitudinal axis of the magnetically conductive conduit.

The apparatus of the instant invent may further comprise a housing enclosing at least the coiled electrical conductor.

The fluid flow conduit may comprise at least one coupling device, each coupling device establishing a conduit segment comprising a non-magnetically conductive material defining a fluid impervious boundary wall with an inner surface and an outer surface and having inlet and outlet ports. The inlet and outlet ports of a coupling device may be adapted to receive a segment of conduit and provide for the fluid impervious, non-contiguous connection between the magnetically energized conduit and an additional segment of conduit. This non-contiguous connection establishes a non-magnetically conductive region between the magnetically energized conduit and the additional segment of conduit. A non-contiguous connection between the magnetically energized conduit and an additional segment of magnetically conductive conduit provides for a concentration of magnetic energy in the space between the magnetically conductive conduits.

The fluid flow conduit may comprise at least one length of non-magnetically conductive conduit, each at least length of one conduit establishing a conduit segment comprising a non-magnetically conductive material defining a fluid impervious boundary wall with an inner surface and an outer surface and having inlet and outlet ports. One port of the length of non-magnetically conductive conduit may be adapted to provide for the fluid impervious connection between an end of the magnetically energized conduit and the non-magnetically conductive length of fluid flow conduit, with the connection establishing a non-magnetically conductive region at that end of the magnetically energized conduit.

The fluid flow conduit may comprise at least one segment of conduit within a piping system comprising a non-magnetically conductive material sleeved within the boundary wall of the magnetically energized conduit. A first fluid flow conduit and a second fluid flow conduit may be sleeved within the boundary wall of the magnetically conductive conduit. Each at least one segment of non-magnetically conductive conduit may promote the flow of a fluid through a plurality of distinct points of magnetic fluid treatment.

The boundary wall of the magnetically conductive conduit may be split along its longitudinal axis into preferably equal sections then rejoined proximate the outer surface of the fluid flow conduit to sleeve the non-magnetically conductive fluid flow conduit. A sheet of magnetically conductive material may be rolled in concentric surrounding relation the outer surface of the fluid flow conduit to establish a magnetically conductive conduit sleeving the non-magnetically conductive fluid flow conduit.

The conductor leads of the coiled electrical conductor may be coupled to at least one electrical power supply to produce a magnetic field having energy substantially confined within the boundary wall of the magnetically conductive conduit. The supply of electrical power is of sufficient magnitude to induce a magnetic field to fluid passing through the magnetically conductive conduit.

The at least one electrical power supply may provide a plurality of distinct programmable outputs of electrical energy. A first output of electrical energy may establish at least one distinct electrical signal providing a constant flow of electrical energy having a direct current component. The voltage and current of a constant flow of electrical energy energizing the coiled electrical conductor may be established according to one or more of the composition of a fluid to be treated, material comprising the coiled electrical conductor, dimensions of the coiled electrical conductor, configuration of the coiled electrical conductor, resistance of the coiled electrical conductor, material comprising the coil core, dimensions of the coil core, configuration of the coil core, resistance of the coil core, material comprising the magnetically conductive conduit, dimensions of the magnetically conductive conduit, configuration of the magnetically conductive conduit, material comprising the at least one non-magnetically conductive fluid flow conduit, dimensions of the at least one non-magnetically conductive fluid flow conduit and configuration of the at least one non-magnetically conductive fluid flow conduit.

A second output of electrical energy may establish at least one distinct electrical signal providing a pulsed flow of electrical energy having a direct current component. The voltage, current, repetition rate, amplitude and wavelength of a pulsed electrical signal having a direct current component and energizing the coiled electrical conductor may be established according to one or more of the composition of a fluid to be treated, material comprising the coiled electrical conductor, dimensions of the coiled electrical conductor, configuration of the coiled electrical conductor, resistance of the coiled electrical conductor, material comprising the coil core, dimensions of the coil core, configuration of the coil core, resistance of the coil core, material comprising the magnetically conductive conduit, dimensions of the magnetically conductive conduit, configuration of the magnetically conductive conduit, material comprising the at least one non-magnetically conductive fluid flow conduit, dimensions of the at least one non-magnetically conductive fluid flow conduit and configuration of the at least one non-magnetically conductive fluid flow conduit.

A third output of electrical energy may establish at least one distinct electrical signal providing a pulsed flow of electrical energy having an alternating current component. The voltage, current, repetition rate, amplitude and wavelength of a pulsed electrical signal having an alternating current component and energizing the coiled electrical conductor may be established according to one or more of the composition of a fluid to be treated, material comprising the coiled electrical conductor, dimensions of the coiled electrical conductor, configuration of the coiled electrical conductor, impedance of the coiled electrical conductor, material comprising the coil core, dimensions of the coil core, configuration of the coil core, resistance of the coil core, material comprising the magnetically conductive conduit, dimensions of the magnetically conductive conduit, configuration of the magnetically conductive conduit, material comprising the at least one non-magnetically conductive fluid flow conduit, dimensions of the at least one non-magnetically conductive fluid flow conduit and configuration of the at least one non-magnetically conductive fluid flow conduit.

A single electrical power supply may be utilized to energize a single coiled electrical conductor with an electrical signal, or a first electrical power supply may be utilized to energize a first coiled electrical conductor with a first electrical signal and a second electrical power supply may be utilized to energize a second coiled electrical conductor with a second electrical signal. The second electrical power supply may establish a second electrical signal substantially equivalent in electrical characteristics to the first electrical signal energizing the first coiled electrical conductor or the second electrical power supply may establish a second electrical signal having electrical characteristics distinct from the first electrical signal energizing the first coiled electrical conductor.

An electrical power supply may provide a plurality of distinct programmable outputs of electrical energy, with each output of electrical energy establishing a distinct electrical signal wherein a first electrical signal energizes a first coiled electrical conductor and a second electrical signal energizes a second coiled electrical conductor. The first electrical signal may have electrical characteristics distinct from the second electrical signal or the first electrical signal may have electrical characteristics substantially equivalent to the second electrical signal.

The first and second time intervals and the repetition rate of a pulsed electrical signal may be substantially constant or one or more of the first and second time intervals and the repetition rate of a pulsed electrical signal may be variable. A pulsed electrical signal may be of a substantially constant amplitude or a pulsed electrical signal may be of a variable amplitude. The wavelength of a pulsed electrical signal may be substantially constant or the wavelength of a pulsed electrical signal may be variable.

In all instances, at least one distinct electrical signal having a capacity to energize the coiled electrical conductor may be utilized to produce a magnetic field having energy substantially confined within the boundary wall of the magnetically conductive conduit, said magnetic field extending beyond an end of each length of magnetically conductive material comprising said magnetically conductive conduit and having energy concentrated in a plurality of distinct areas along the longitudinal axis of the magnetically energized conduit.

A feed stream may be directed to pass through at least one chemical dispersing apparatus providing means for distributing a supply of at least one fluid treatment chemical into a feed stream. As used herein, examples of a supply of a fluid treatment chemical may be selected from a group consisting of algaecides, biocides, scale retardants, pesticides, fertilizers, coolants, ambient air, oxygen, ozone, hydrogen peroxide, surfactants, petroleum production fluid additives, fuel additives and lubricant additives. Other fluid treatment chemicals may be dispersed into a feed stream.

A feed stream may be directed to pass through at least one contaminant separation apparatus, said at least one separation apparatus providing means for separating and collecting a volume of contaminants from a fluid column and discharging a processed feed stream having a reduced volume of contaminants carried within a treated fluid column. As used herein, examples of contaminant separation apparatus may be selected from a group consisting of electrocoagulation treatment systems, reverse osmosis equipment, two-phase separation systems, three-phase separation systems, solids separation equipment, dewatering devices, oil/water separators, desalination equipment, petroleum production equipment, petroleum refining systems, water filters, fuel filters and lubricant filters. Other contaminant separation apparatus may be utilized to separate and collect a volume of contaminants from a fluid.

A feed stream may be directed to pass through at least one fluid flow conditioning apparatus, said at least one fluid conditioning apparatus providing means for conditioning the flow of a fluid directed to pass through a treatment device. As used herein, examples of a fluid conditioning apparatus may be selected from a group consisting of laminar fluid flow conditioners, vortex inducing fluid flow equipment, static mixing devices and dynamic mixing apparatus. Other fluid flow conditioning apparatus may be utilized to condition the flow of a feed stream.

The foregoing description of the preferred embodiment has been for the purpose of explanation and illustration. It will be appreciated by those skilled in the art that modifications and changes may be made without departing from the essence and scope of the present invention. Therefore, it is contemplated that the appended claims will cover any modifications or embodiments that fall within the scope of the invention.

What is claimed is:

1. A method of providing fluid treatment, comprising the steps of:
providing a magnetically conductive conduit, said magnetically conductive conduit comprising at least one length of magnetically conductive material defining a fluid impervious boundary wall with an inner surface and an outer surface and having a port at the proximal end of the conduit and a port at the distal end of the conduit;
providing at least one fluid flow conduit to promote a flow of a fluid through the magnetically conductive conduit, each at least one fluid flow conduit comprising a length of non-magnetically conductive material defining a fluid impervious boundary wall with an inner surface and an outer surface and having inlet and outlet ports;
providing an electrical conductor, said electrical conductor comprising at least one length of an electrical conducting material having a first conductor lead and a second conductor lead;
coiling the electrical conductor to form at least one uninterrupted layer of coiled electrical conductor;
providing means for sleeving the magnetically conductive conduit within the coiled electrical conductor, whereby at least one coil of electrical conductor encircles at least a segment of the outer surface of each length of magnetically conductive material comprising said magnetically conductive conduit;
providing means for deploying the at least one fluid flow conduit proximate the magnetically conductive conduit;
providing at least one electrical power supply, each at least one electrical power supply providing at least one distinct programmable output of electrical energy wherein one or more of the voltage, current, repetition rate, amplitude or wavelength of the programmable output establishes at least one distinct electrical signal;
connecting the conductor leads of the coiled electrical conductor to the at least one electrical power supply to energize the coiled electrical conductor and produce a magnetic field having energy substantially confined within the boundary wall of the magnetically conductive conduit, said magnetic field extending beyond an end of each length of magnetically conductive material comprising said magnetically conductive conduit and having energy concentrated in a plurality of distinct areas along the longitudinal axis of the magnetically energized conduit;
introducing a feed stream comprising a fluid column receptive to magnetic treatment to the inlet port of at least one fluid flow conduit to establish a flow of a fluid to be treated through proximal end of the magnetically conductive conduit;
directing the flow to pass through the plurality of distinct areas of concentrated magnetic energy along a path extending through and substantially orthogonal to each turn of the electrical conductor forming the coil surrounding the outer surface of the magnetically conductive conduit; and
discharging the fluid exiting from the port at the distal end of the magnetically conductive conduit a processed feed stream.

2. The method of claim 1 wherein the coiled electrical conductor induces a magnetic field to which fluid passing through the magnetically conductive conduit is exposed.

3. The method of claim 1 wherein the supply of electrical power is of sufficient magnitude to induce a magnetic field to fluid passing through the magnetically conductive conduit.

4. The method of claim 1 wherein the at least one output of electrical energy establishes at least one distinct electrical signal providing a constant flow of electrical energy having a direct current component.

5. The method of claim 1 wherein the at least one output of electrical energy establishes at least one distinct electrical signal providing a pulsed flow of electrical energy having a direct current component.

6. The method of claim 1 wherein the at least one output of electrical energy establishes at least one distinct electrical signal providing a pulsed flow of electrical energy having an alternating current component.

7. The method of claim 1 further comprising the step of dispersing a supply of at least one fluid treatment chemical into the feed stream.

8. The method of claim 1 further comprising the step of directing the feed steam to pass through at least one contaminant separation process.

9. The method of claim 1 further comprising the step of directing the feed steam to pass through at least one fluid flow conditioning process.

10. An apparatus providing fluid treatment, comprising:
a magnetically conductive conduit, said magnetically conductive conduit comprising at least one length of magnetically conductive material defining a fluid impervious boundary wall with an inner surface and an outer surface and having a port at the proximal end of the conduit and a port at the distal end of the conduit;
at least one fluid flow conduit to promote a flow of a fluid through the magnetically conductive conduit, each at least one fluid flow conduit comprising a length of non-magnetically conductive material defining a fluid impervious boundary wall with an inner surface and an outer surface and having inlet and outlet ports;
an electrical conductor comprising at least one length of an electrical conducting material having a first conductor lead and a second conductor lead, said electrical conductor coiled to form at least one uninterrupted layer of coiled electrical conductor;
means for sleeving the magnetically conductive conduit within the coiled electrical conductor, whereby at least one coil of electrical conductor encircles at least a segment of the outer surface of each length of magnetically conductive material comprising said magnetically conductive conduit;
means for deploying the at least one fluid flow conduit proximate the magnetically conductive conduit; and
at least one electrical power supply providing at least one distinct programmable output of electrical energy wherein one or more of the voltage, current, repetition rate, amplitude or wavelength of the programmable output establishes at least one distinct electrical signal having a capacity to energize the coiled electrical conductor and produce a magnetic field having energy substantially confined within the boundary wall of the magnetically conductive conduit, said magnetic field extending beyond an end of each length of magnetically conductive material comprising said magnetically conductive conduit and having energy concentrated in a plurality of distinct areas along the longitudinal axis of the magnetically energized conduit.

11. The apparatus of claim 10 further comprising a coil core, said coil core comprising a tubular conduit defining a boundary wall with an inner surface and an outer surface and having a port at the proximal end of the tube and a port at the distal end of the tube, the outer surface of said boundary wall adapted to receive the coiled electrical conductor and the inner surface of said boundary wall adapted to sleeve the magnetically conductive conduit, whereby the inner surface of the boundary wall of said coil core is coaxially disposed in substantially concentric surrounding relation to the outer surface of the boundary wall of said magnetically conductive conduit.

12. The apparatus of claim 10 wherein the electrical conductor forms a first layer of coiled electrical conductor and a second layer of coiled electrical conductor, said first and second layers of coiled electrical conductor being coaxially disposed and having a plurality of spacers deployed between said coil layers to establish radial spacing therebetween, said spacers arranged substantially parallel to the longitudinal axis of the magnetically conductive conduit and equidistant to an adjacent spacer to form a pattern of open-air cooling ducts extending substantially parallel to the longitudinal axis of the magnetically conductive conduit.

13. The apparatus of claim 10 further comprising a housing enclosing at least the coiled electrical conductor.

14. The apparatus of claim 10 wherein the fluid flow conduit comprises at least one coupling device, each coupling device establishing a conduit segment comprising a non-magnetically conductive material defining a fluid impervious boundary wall with an inner surface and an outer surface and having inlet and outlet ports, said inlet and outlet ports adapted to receive a segment of conduit and provide for the fluid impervious, non-contiguous connection between the magnetically energized conduit and an additional segment of conduit, said non-contiguous connection establishing a non-magnetically conductive region between the magnetically energized conduit and the additional segment of conduit.

15. The apparatus of claim 10 wherein the fluid flow conduit comprises at least one length of conduit, each at least one length of conduit establishing a conduit segment comprising a non-magnetically conductive material defining a fluid impervious boundary wall with an inner surface and an outer surface and having inlet and outlet ports, whereby of one port is adapted to provide for the fluid impervious connection between an end of the magnetically energized conduit and said non-magnetically conductive fluid flow conduit, said connection establishing a non-magnetically conductive region at that end of the magnetically energized conduit.

16. The apparatus of claim 10 wherein the fluid flow conduit comprises at least one segment of non-magnetically conductive conduit within a piping system sleeved within the boundary wall of the magnetically energized conduit.

17. The apparatus of claim 10 wherein the at least one output of electrical energy establishes at least one distinct electrical signal providing a constant flow of electrical energy having a direct current component.

18. The apparatus of claim 10 wherein the at least one output of electrical energy establishes at least one distinct electrical signal providing a pulsed flow of electrical energy having a direct current component.

19. The apparatus of claim 10 wherein the at least one output of electrical energy establishes at least one distinct electrical signal providing a pulsed flow of electrical energy having an alternating current component.

20. The apparatus of claim 10 further comprising a first electrical power supply energizing a first coiled electrical conductor with a first electrical signal and a second electrical power supply energizing a second coiled electrical conductor with a second electrical signal.

21. The apparatus of claim 10 wherein the electrical power supply provides a plurality of distinct programmable outputs of electrical energy, each output of electrical energy establishing a distinct pulsed electrical signal wherein a first electrical signal energizes a first coiled electrical conductor and a second electrical signal energizes a second coiled electrical conductor.

22. The apparatus of claim 10 further comprising at least one chemical dispersing apparatus, said at least one dispersing apparatus providing means for distributing a supply of at least one fluid treatment chemical into a fluid.

23. The apparatus of claim 10 further comprising at least one contaminant separation apparatus, said at least one separation apparatus providing means for separating and collecting a volume of contaminants from a fluid column and discharging a processed feed stream having a reduced volume of contaminants carried within a treated fluid column.

24. The apparatus of claim 10 further comprising at least one fluid flow conditioning apparatus, said at least one fluid conditioning apparatus providing means for conditioning the flow of a fluid directed to pass through a treatment device.
